(19) United States
(12) Patent Application Publication
(10) Pub. No.: US 2017/0241368 A1
(43) Pub. Date: Aug. 24, 2017

(54) DUCTED COMBUSTION SYSTEM

(71) Applicant: Caterpillar Inc., Peoria, IL (US)

(72) Inventors: Jonathan W. Anders, Peoria, IL (US); Christopher R. Gehrke, Chillicothe, IL (US); Yongli Qi, Peoria, IL (US)

(73) Assignee: Caterpillar Inc., Peoria, IL (US)

(21) Appl. No.: 15/046,667

(22) Filed: Feb. 18, 2016

(51) Int. Cl. F02D 41/40; F02F 1/24

(52) U.S. Cl. CPC F02D 41/403; F02D 41/405; F02F 1/24

(57) ABSTRACT

A ducted combustion system for an internal combustion. The ducted combustion system includes a combustion chamber, a fuel injector in fluid communication with the combustion chamber and configured to inject a sequence of at least two fuel charges into a combustion chamber during a combustion cycle and one or more ducts disposed within the combustion chamber and configured to receive at least a part of the fuel charges.

### TECHNICAL FIELD

The present disclosure generally relates to internal combustion engines and, more particularly, relates to ducted combustion systems for internal combustion engines.

### BACKGROUND

Modern combustion engines may include one or more cylinders as part of the engine. The cylinder and an associated piston may define a combustion chamber. Fuel for combustion may be directly injected into the combustion chamber using various injection systems associated with the cylinders.

During engine operation, the injection systems may inject varying amounts of fuel/air mixture or fuel into the combustion chamber. Different mixtures and/or equivalence ratios of the fuel/air mixture within the fuel jet may produce different results during combustion. The manner in which the injected fuel mixes and/or interacts with the air and other environmental elements of the combustion chamber may impact combustion processes and associated emissions. Further, if the fuel and air mixing is inadequate, then suboptimal or incomplete combustion may take place which may create large amount of soot within the combustion chamber.

U.S. Patent Publication No. 2012/0186555 discloses ducted combustion within a combustion engine. The ducted combustion helps prevent/reduce soot formation within the combustion chamber. The '555 document discloses ducts which include fins disposed around a fuel jet injected by a fuel injector. Such ducts may form a passageway corresponding to an orifice of the fuel injector, into which fuel jets are injected. The fuel jets may be channeled into the ducts, which may improve fuel combustion as upstream regions of the fuel jet may be affected by faster and more uniform mixing as well as by an inhibition or reduction of entrainment of combustion products from downstream regions of the same or neighboring jets.

While the teachings of the '555 application are advantageous in providing an improved fuel/air mixture, further improvements in fuel/air mixtures are always desired, as such improvements may further reduce emissions and soot formation.

### SUMMARY OF THE INVENTION

In an aspect of the present disclosure, a ducted combustion system for an internal combustion is disclosed. The ducted combustion system includes a combustion chamber, a fuel injector in fluid communication with the combustion chamber and configured to inject a sequence of at least two fuel charges into a combustion chamber during a combustion cycle and one or more ducts disposed within the combustion chamber and configured to receive at least a part of the fuel charges.

In another aspect of the present disclosure, an engine system is disclosed. The engine system includes a combustion chamber, a fuel injector in fluid communication with the combustion chamber and configured to inject a sequence of at least two fuel charges into a combustion chamber during a combustion cycle and one or more ducts disposed within the combustion chamber such that the at least two fuel charges at least partially enters the one of the one or more ducts.

In yet another aspect of the present disclosure, a method for operating an internal combustion engine is disclosed. The method includes injecting a sequence of at least two fuel charges into a combustion chamber during a combustion cycle. Further, the method includes directing at least a part of the fuel charges into one or more ducts disposed in the combustion chamber configured to provide a substantially uniform mixture of fuel and air within the combustion chamber.

### BRIEF DESCRIPTION OF THE DRAWINGS

FIG. 1 is a cross sectional view of an exemplary engine configured to produce power.

FIG. 2 illustrates a cross-sectional view of an engine showing the ducted combustion system in accordance with an embodiment of the present disclosure.

FIG. 3 illustrates a cross sectional view of the engine in accordance with an embodiment of the present disclosure.

FIG. 4 illustrates a diagrammatic view of a fuel jet prior before passing through the duct.

FIG. 5 illustrates a diagrammatic view of a fuel jet wherein a leading edge of the fuel jet interacts with duct walls.

FIG. 6 illustrates a diagrammatic view of a fuel jet wherein a middle portion of the fuel jet interacts with the duct walls.

FIG. 7 illustrates a diagrammatic view of a fuel jet wherein a trailing edge of the fuel jet interacts with the duct walls.

FIG. 8 depicts a method of operating the engine in accordance with an embodiment of the present disclosure.

### DETAILED DESCRIPTION

Reference will now be made in detail to embodiments of the invention, examples of which are illustrated in the accompanying drawings. Wherever possible, the same reference numbers will be used throughout the drawings to refer to the same or like parts.

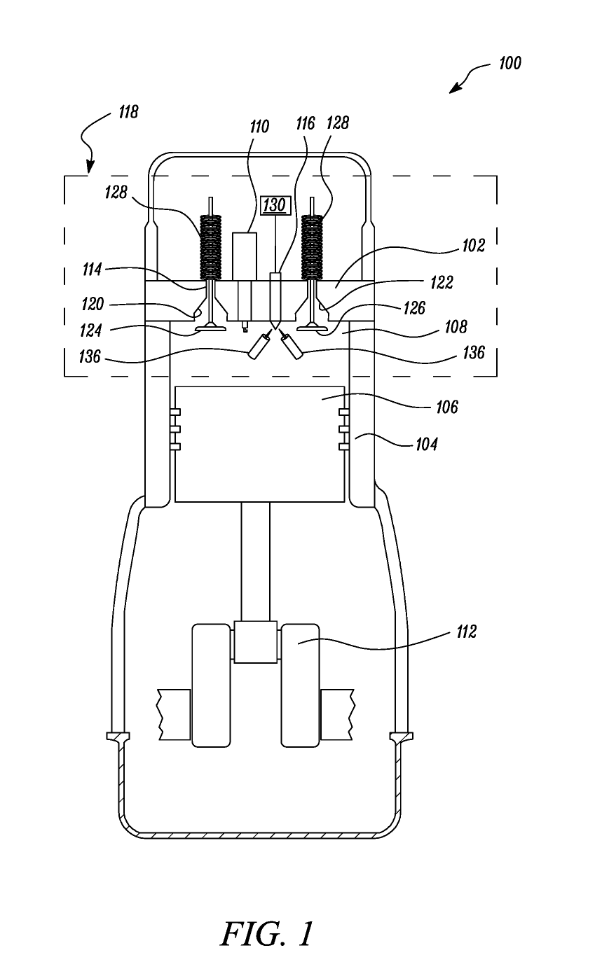

The present disclosure relates to a ducted combustion system for improving the combustion process and avoiding unwanted emissions into the atmosphere. FIG. 1 illustrates an exemplary engine 100 configured to power any vehicle. The engine 100 may be any engine running on solid, liquid or gaseous fuel, used for various purposes such as a power generation, a marine vessel, an automobile, a construction machine, any transportation vehicle and the like. In an embodiment, the engine 100 may be an internal combustion engine running on a hydrocarbon fuel.

Referring to FIG. 1, an embodiment of the engine 100 includes a ducted combustion system 118. The ducted combustion system 118 includes a cylinder head 102 and a cylinder block 104. The cylinder head 102, the cylinder block 104 and a piston 106 define a combustion chamber 108. In an alternate embodiment, the internal combustion engine 100 may have a plurality of combustion chambers 108. The combustion chamber 108 is configured to receive air-fuel mixture i.e. charge. The charge is burnt and the piston 106 is configured to transmit the driving force created by the burning charge to an output shaft 112. In the embodiment illustrated, the output shaft 112 is the crankshaft of the engine 100.

As shown in FIG. 1, the cylinder head 102 defines one or more valve openings 114 for receiving a valve. An intake valve 124 and an exhaust valve 126 are disposed at least partially in the valve openings 114 of an intake port 120 and an exhaust port 122 respectively. The intake valve 124 and/or the exhaust valve 126 may have a spring or an elastic element 128. The spring element 128 is configured to bias the associated intake valve 124/exhaust valve 126 to its closed position. In various other embodiments, the spring element 128 may be any other type of biasing mechanism that can be used to bias the intake valve 124/exhaust valve 126 to its closed position.

The intake valve 124 is configured to supply the air received from an air introducing system (not shown) into the combustion chamber 108. When the intake valve 124 is in an open position, the intake port 120 is in fluid communication with the combustion chamber 108 and air may be introduced into the combustion chamber 108. The opening of the intake valve 124 leads to the spring element 128 developing a restoring force to restore the intake valve 124 to its closed position. The restoring force of the spring element 128 brings the intake valve 124 to its closed position.

The exhaust valve 126 is configured to facilitate discharge of the combustion products from the combustion chamber 108. When the exhaust valve 126 is in an open position, the exhaust port 122 is in fluid communication with the combustion chamber 108 and exhaust/combusted gases may advance from the combustion chamber 108 and into the exhaust port 122. The opening of the exhaust valve 126 leads to the spring element 128 developing a restoring force to restore the exhaust valve 126 into its closed position. The restoring force of the spring element 128 brings the exhaust valve 126 to its closed position.

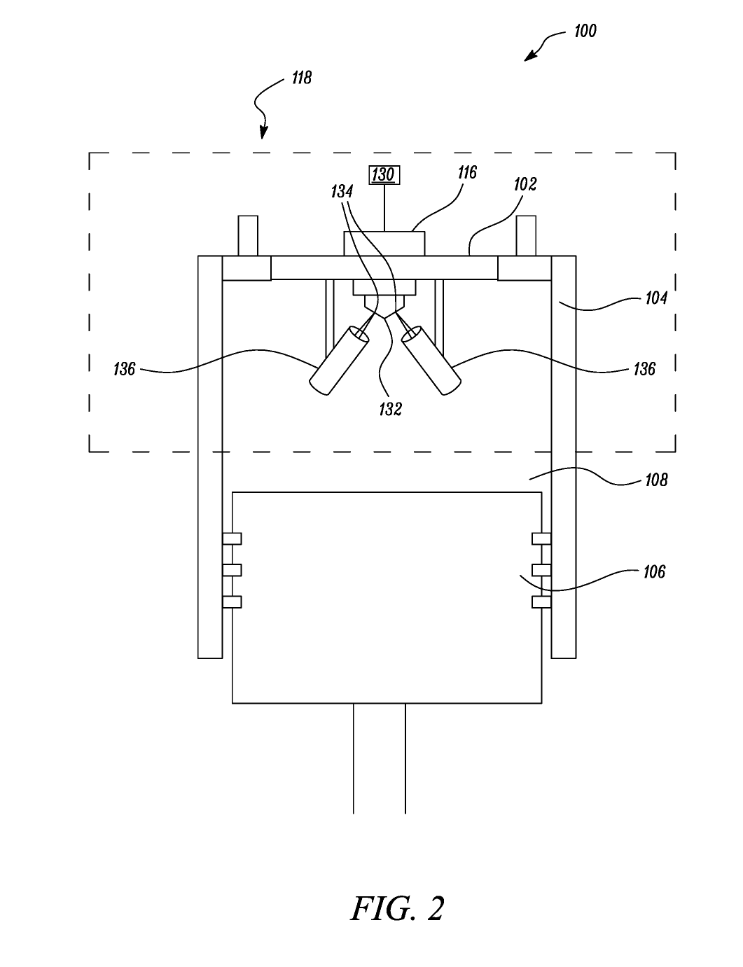

The ducted combustion system 118 further includes a fuel introducing system 116. The fuel introducing system 116 may be disposed on the cylinder head 102, as shown in FIG. 2. The fuel introducing system 116 is configured to supply fuel charge into the combustion chamber 108. In the embodiment illustrated the fuel introducing system 116 is a fuel injector. The fuel injector 116 includes a tip 132. The tip 132 is in fluid communication with the combustion chamber 108. Using the tip 132, the fuel injector 116 is configured to directly inject a sequence of at least two fuel charges into the combustion chamber 108 during a combustion cycle. The combustion cycle is a cycle wherein fuel is introduced into the combustion chamber 108 to prepare a mixture of air and fuel. Further, in the combustion cycle the air fuel mixture is compressed and then ignited to provide a mechanical output using the output shaft 112. The combustion products are then removed from the combustion chamber 108. This combustion cycle is then repeated to provide the desired power output. The combustion cycle generally include an intake stroke, a compression stroke, a power stroke and an exhaust stroke. The combustion cycle may be any cycle such as a two stroke cycle (spark ignited/compression ignited), a four stroke cycle (spark ignited/compression ignited), a dual fuel cycle, a five stroke cycle, a six stroke cycle, Miller cycle, Atkinson cycle or any other cycle known in the art. It may be contemplated that the fuel introducing system 116 may be any system such as a direct injection system or any other fuel injection system known in the art.

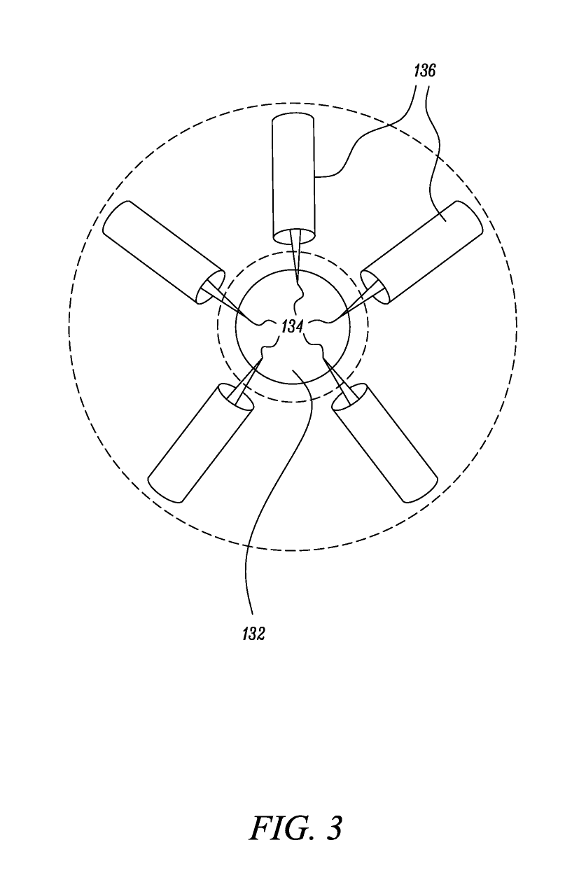

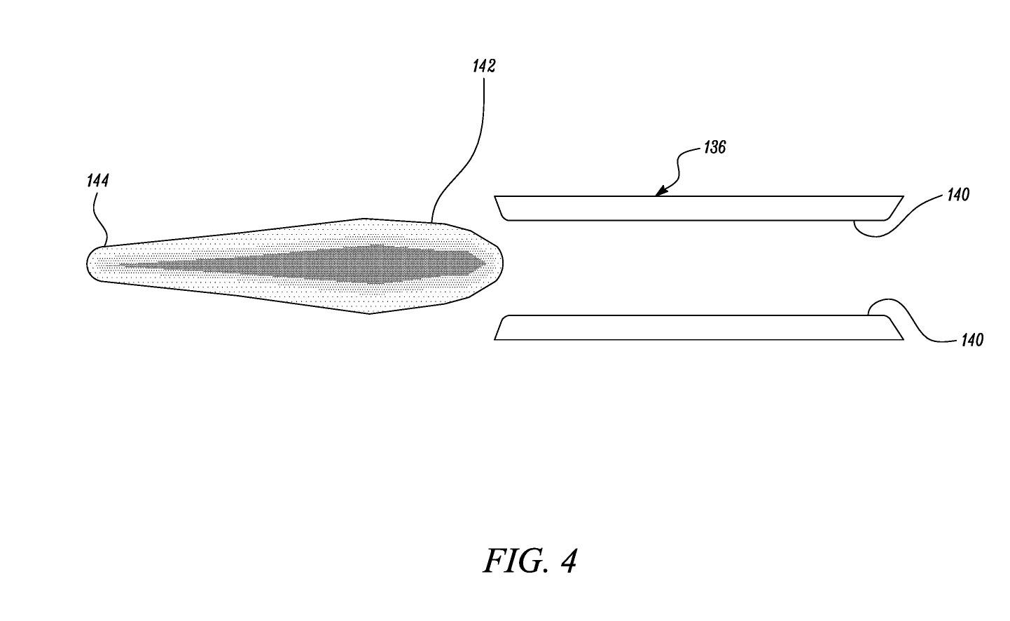

The ducted combustion system 118 further comprises a duct 136, as shown in FIG. 3. The duct 136 has duct walls 140 as shown in FIG. 4. The duct 136 may be disposed within the combustion chamber 108 proximate to the tip 132 of the fuel injector 116. The duct 136 is positioned such that the fuel charge injected by the tip 132 of the fuel injector 116 may, at least partially, pass through the duct 136. In an embodiment, the engine 100 may have a plurality of ducts 136 disposed proximate to the tip 132 of the fuel injector 116, as shown in FIG. 3. The fuel injector 116 may have one or more orifices 136 to inject fuel jets into the plurality of ducts 136. In the embodiment illustrated, the ducts 136 are tubes. In an alternate embodiment, the ducts 136 may be a tubular shaped structure having a variable diameter. In various other embodiments, the ducts 136 may be a tubular structures modified to alter the fuel/air mixture either within the duct 136 or outside the duct 136.

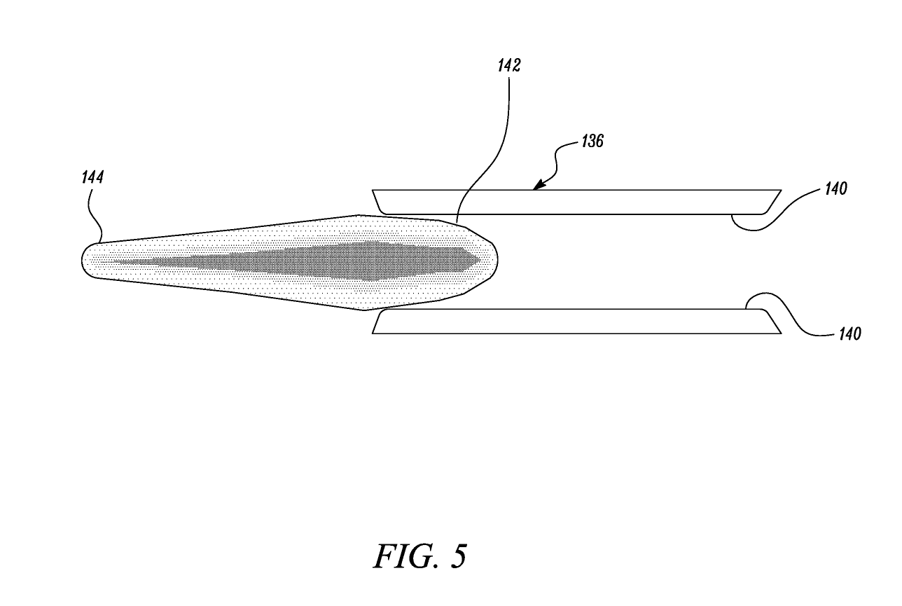

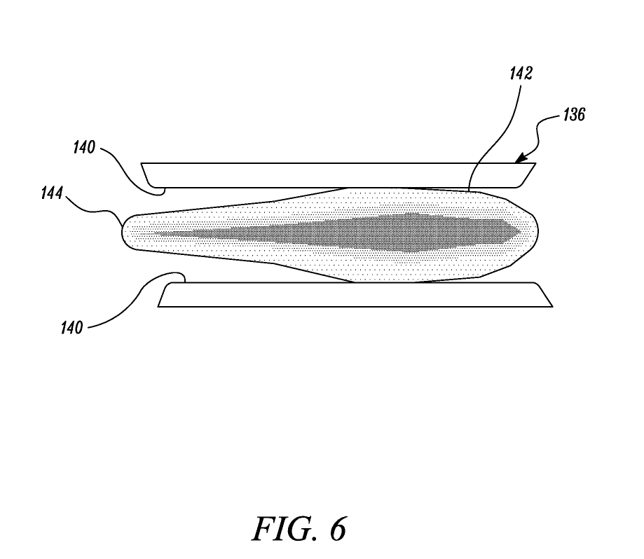

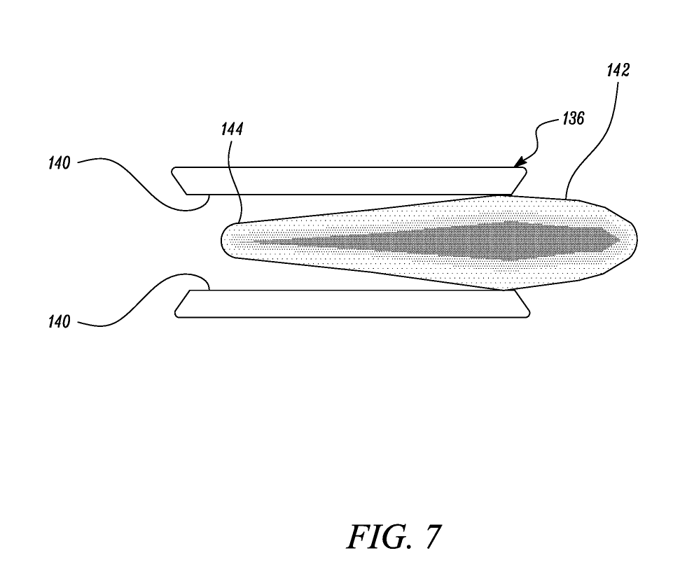

The ducts 136 are configured to interact with the fuel charge injected by the fuel injector 116 and alter the entrainment and combustion characteristics. In the embodiment illustrated in FIG. 2 and FIG. 4-7, the fuel jet injected into the combustion chamber 108 has a leading edge 142 and a trailing edge 144. The fuel jet thickness is maximum near the leading edge 142 and the thickness reduces toward the trailing edge 144. In a transient jet, the fuel jet thickness in the vicinity of the leading edge 142 can be more than the spreading angle a steady jet would produce. As shown in FIG. 4, the fuel jet injected by the fuel injector 116 interacts with the duct walls 140 such that the transient leading edge 142 of the fuel jet attaches to the duct walls 140. However, as the fuel jet moves forward in the duct the middle portion and the trailing edge 144 also attach themselves to the duct walls 140, as shown in FIG. 6 and FIG. 7. Thus, widening the fuel jet injected into the combustion chamber 108. This widening of the fuel jet promotes mixing of air and fuel within the combustion chamber 108. This widening of the fuel jet can be transient in nature associated with the passage of the wider leading edge 142 of the jet through the duct. Further, when the fuel jet interacts with the duct walls 140 the velocity of fuel jet is substantially preserved. The preserved velocity can also enhance mixing within the combustion chamber as the trailing edge 144 of the jet passes through and exits the duct 108.

The ducted combustion system 118 may further have an electronic control unit (ECU) 130 as shown in FIG. 1 and FIG. 2. The electronic control unit ECU 130 may be a digital computer that may include a central processing unit (CPU), a read-only-memory (ROM), a random access memory (RAM), and an output interface. The ECU 130 receives input signals from various sensors (not illustrated) that represent various engine operating conditions. For example, an accelerator opening signal from an accelerator opening sensor may detect engine load, a water temperature signal from a water temperature sensor may detect engine temperature, and a crank angle signal from a crank angle sensor may detect the angular position of a crankshaft (not shown), and which may be used by the ECU 130 to calculate engine rotation speed (e.g., number of revolutions per minute of the engine 100). In response to the input signals, the ECU 130 controls various parameters that govern operation of the engine 100. For example, the ECU 130 may control the amount and timing of the air injected by the intake valve 124. Further, the ECU 130 may also control the injection strategy (events/timings/amounts) of the fuel jets injected by the fuel injector 116.

In accordance with a given operating condition of the engine 100, the ECU 130 controls the injection timing of the plurality of fuel charges injected through the fuel injector 116. For e.g. based on the operating conditions of the engine 100, the ECU 130 may transmit at least two signals to the fuel injector 116 to provide two fuel charges within the combustion chamber 108 at two different instants of time. In an embodiment, the first fuel charge may be a pilot injection i.e. an injection event prior to completion of a compression stroke and before the main injection event. In an alternate embodiment, one of the at least two fuel charges may be a post injection i.e. an injection event after the completion of a main injection and during a power stroke. In various other embodiments, the fuel charges may be injected at different crank angles for e.g. in an embodiment there may be a plurality of fuel charges injected starting from 30 degrees before TDC (during compression stroke) to 40 degrees after completion of the compression stroke with 2 to 8 injection events.

In accordance with a given operating condition of the engine 100, the ECU 130 controls the amount of fuel injected through the plurality of fuel charges injected through the fuel injector 116 for e.g. in an embodiment a sequence of four fuel charges may be injected by the fuel injector 116. All the four fuel charges may inject the same amount of fuel into the combustion chamber 108. In an alternate embodiment, a sequence of three fuel charges may be injected into the combustion chamber 108. In this case different amount of fuel may be injected by each of the three fuel charges. For e.g. the first fuel charge may inject 20 percent fuel, the second fuel charge may inject 65 percent fuel and the third fuel charge may inject the remaining 15 percent fuel for the combustion cycle. It may be contemplated that any number of fuel charges may be injected by the fuel injector 116 wherein each of the fuel charge may deliver the same amount of fuel or a different amount of fuel into the combustion chamber 108.

The working of the engine 100 along with the ECU 130 will now be explained in detail with reference to FIG. 2-6. During normal engine 100 operation, a combustion cycle takes place and converts the chemical energy of the charge to give mechanical energy. For example, the combustion cycle may comprise of four cycle periods i.e. an intake stroke, a compression stroke, a power stroke and an exhaust stroke. Firstly an intake stroke takes place during the combustion cycle. During this stroke the intake valve 124 is opened by an intake cam (not shown) while the exhaust valve 126 is in a closed position. Further, during this stroke the piston 106 starts moving from a top dead center to a bottom dead center. Due to the downward motion of the piston 106 vacuum pressure is created which pulls some air from the intake valves 124 into the combustion chamber 108.

When the piston 106 reaches its bottom dead center the compression stroke is initiated. During the compression stroke both the intake valve 124 and exhaust valve 126 are in their closed position. Further, during the compression stroke, the piston 106 starts moving from the bottom dead center to the top dead center to compress the air within the combustion chamber 108 thereby preparing it for ignition. Simultaneously, the ECU 130 runs various algorithms stored in its memory on the data received from the sensors disposed on the intake valve 124 and the fuel introducing system 116 and predicts a multiple injection strategy to obtain maximum power during a specific operating condition of the engine 100. Close to the end of compression stroke, for e.g. in an embodiment the hot compressed air ignites with a very short delay after start of injection the injecting fuel through the fuel injector 116 into the combustion chamber 108. In the embodiment illustrated, when the air has been compressed by the piston 106, the ECU 130 transmits a signal to the fuel injector 116 based on the predicted injection strategy, to inject at least a sequence of two fuel charges, via the tip 132, into the combustion chamber 108 during the combustion cycle. The fuel injector 116 injects fuel charges as fuel jets through the one or more orifices 134 into the one or more ducts 136. The fuel jets interact with the duct walls 140. After interacting with the ducts walls 140 the fuel jets disperse within the combustion chamber 108 to create a uniform fuel/air mixture within the combustion chamber 108. The compressed charge may then be ignited by the heat generated by the high compression pressure generated in case the engine 100 is a diesel engines.

When the piston 106 reaches the top dead center after completing the compression stroke a power stroke is initiated. The power stroke marks the start of the second revolution of the combustion cycle. At this point the output shaft 112 has completed a full 360 degree revolution. During this stroke both the intake valve 124 and the exhaust valve 126 are in the closed position.

In an alternate embodiment, an ignition plug 110 may be disposed at least partially in the combustion chamber 108. The ignition plug 110 may be connected with the cylinder head 102 by a threaded connection or other methods known in the art. The ignition plug 110 may be a typical J-gap spark plug, a spark plug with a pre-chamber, rail plug, extended electrode, or laser plug or any other type of spark plug known in the art. The air/fuel mixture may be ignited using the ignition plug 110 in case the engine 100 is a spark ignited engine. Igniting the charge creates an explosion within the combustion chamber 108 and forcefully moves the piston 106 from the top dead center to the bottom dead center. This stroke produces mechanical work from the engine 100 to turn the output shaft 112.

Finally the exhaust stroke is initiated. During this stroke the piston 106 starts returning from the bottom dead center to the top dead center. The exhaust valve 126 is always in its open position during the exhaust stroke. The upward motion of the piston 106 along with the exhaust valve 126 in its open position, during the exhaust stroke, facilitates the products of combustion (combusted charge) to escape the combustion chamber 108.

### INDUSTRIAL APPLICABILITY

Modern combustion engines may include one or more cylinders as part of the engine. The cylinder and an associated piston may define a combustion chamber. Fuel for combustion may be directly injected into the combustion chamber using various injection systems associated with the cylinders.

Direct injection systems may inject varying amounts of fuel/air mixture or fuel into the combustion chamber based on the operating conditions of the engine. Different mixtures and/or equivalence ratios of the fuel/air mixture within the fuel jet may produce different results during combustion. Improper mixing of air and fuel cause incomplete combustion. Thereby emitting large volumes of toxic gases and soot into the atmosphere.

In an aspect of the present disclosure, a ducted combustion system 118 for an engine 100 is disclosed. The ducted combustion system 118 comprises a combustion chamber 108, a fuel injector 116 and one or more ducts 136. The ducted combustion system 118 is configured to inject fuel into the combustion chamber 108 using the fuel injector 116. Further, the fuel jets injected by the fuel injector 116 are then passed through the one or more ducts to promote better mixing of air and fuel within the combustion chamber 108.

Within the combustion chamber 108, uniformity of the fuel/air mixture may be relevant to the combustion efficiency and may be relevant to the amount and type of combustion byproducts that are formed. For example, if the fuel/air mixture is too rich in fuel due to insufficient mixing within the fuel jets, then higher soot emissions may occur within the combustion chamber 108 and/or combustion efficiency may be affected. However, in the embodiment illustrated, using one or more ducts 136 disposed within the combustion chamber 108 may provide for more uniform fuel/air mixing within the fuel jets. By using one or more ducts 136, a lift-off length of a flame associated with a fuel jet may be altered (extended or reduced) to achieve an optimized lift-off length favoring low soot formation.

The ducted combustion system 118 provides for better mixing of fuel and air within the combustion chamber 108. Further, the ducted combustion system widens the fuel jet injected by the fuel injector 116 which enhances the entrainment characteristics and accordingly avoids incomplete combustion.

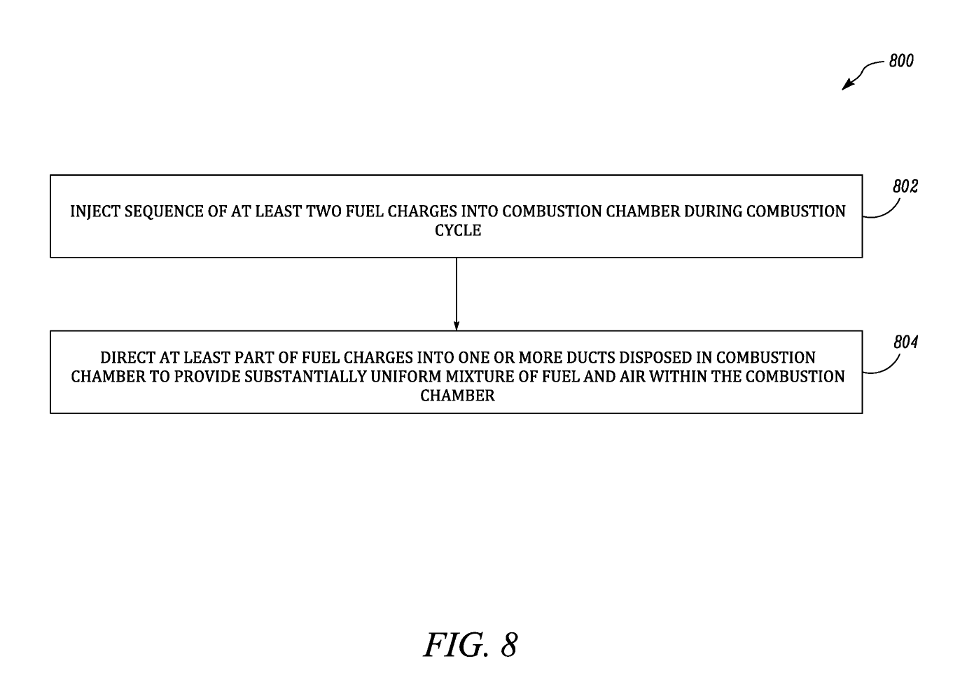

In another aspect of the present disclosure, a method 800 for operating an engine 100 is disclosed. The method 800 will be explained with reference to FIG. 8. During engine 100 operation the ECU 130 receives various signals from the sensors disposed within the engine 100 and its components to calculate the temperature, pressure and amount of air introduced within the combustion chamber 108. The ECU 130 runs at least one algorithm based on the signals from the sensors and decides an appropriate fuel injection strategy wherein the fuel injector 116 injects a sequence of at least two fuel charges within the combustion chamber 108 (Step 802) during the combustion cycle. The fuel from the fuel injector 116 is injected in the form of fuel jets using the plurality of orifices 134. These fuel jets are made to pass at least partially through the plurality of ducts 136 placed proximate to the plurality of orifices 134 (Step 804). This provides for enhanced mixing and provides for a better combustion with minimal levels of soot formation.

The method in present disclosure of injecting a sequence of at least two fuel charges into a combustion chamber during a combustion cycle will enhance the impact of the duct on more uniform mixing by creating multiple leading and trailing edges, therefore may further reduce emissions and soot formation.

While aspects of the present disclosure have seen particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A ducted combustion system for an internal combustion engine comprising:
a combustion chamber;
a fuel injector in fluid communication with the combustion chamber and configured to inject a sequence of at least two fuel charges into the combustion chamber during a combustion cycle; and
one or more ducts disposed within the combustion chamber and configured to receive at least a part of the fuel charges.

2. The ducted combustion system of claim 1, wherein the fuel injector has one or more orifices to inject a fuel charge.

3. The ducted combustion system of claim 2, wherein the one or more orifices are configured to inject the fuel charges into the combustion chamber as one or more fuel jets.

4. The ducted combustion system of claim 1, wherein the one or more ducts are disposed proximate to the one or more orifices of the fuel injector.

5. The ducted combustion system of claim 1, wherein the one or more ducts are tubular shaped structures.

6. The ducted combustion system of claim 1, wherein the sequence of at least two fuel charges includes a pilot injection.

7. The ducted combustion system of claim 1, wherein the sequence of at least two fuel charges includes a post injection.

8. An engine system comprising:
a combustion chamber;
a fuel injector in fluid communication with the combustion chamber and configured to inject a sequence of at least two fuel charges into the combustion chamber during a combustion cycle; and
one or more ducts disposed within the combustion chamber such that the at least two fuel charges at least partially enters the one of the one or more ducts.

9. The engine system of claim 8, wherein the fuel injector has one or more orifices to inject a fuel charge one or more orifices.

10. The engine system of claim 9, wherein the one or more orifices are configured to inject fuel charges into the combustion chamber as one or more fuel jets.

11. The engine system of claim 9, wherein the one or more ducts are disposed proximate to the one or more orifices of the fuel injector.

12. The engine system of claim 8, wherein the one or more ducts are tubular shaped structures.

13. The engine system of claim 8, wherein the sequence of at least two fuel charges includes a pilot injection.

14. The engine system of claim 8, wherein the sequence of at least two fuel charges includes a post injection.

15. A method for operating an internal combustion engine, comprising:
injecting a sequence of at least two fuel charges into a combustion chamber during a combustion cycle; and
directing at least a part of the fuel charges into one or more ducts disposed in the combustion chamber configured to provide a substantially uniform mixture of fuel and air within the combustion chamber.

16. The method of claim 15, further comprising mixing fuel from the fuel jet and air within the duct, once the fuel jet has entered the duct.

17. The method of claim 15, wherein the sequence of at least two fuel charges includes a pilot injection.

18. The method of claim 15, wherein the sequence of at least two fuel charges includes a pilot injection.

19. The method of claim 15, wherein same amount of fuel is injected during each fuel charge.

20. The method of claim 15, wherein different amount of fuel is injected during each fuel charge.
